(19) United States
(12) Patent Application Publication
(10) Pub. No.: US 2008/0190903 A1
(43) Pub. Date: Aug. 14, 2008

(54) Method For Machining Workpieces By Using Laser Radiation

(75) Inventors: Annett Klotzbach, Dresden (DE); Veiko Fleischer, Freiberg (DE); Lothar Morgenthal, Dresden (DE)

Correspondence Address: KAPLAN GILMAN GIBSON & DERNIER L.L.P., 900 ROUTE 9 NORTH, WOODBRIDGE, NJ, 07095, US

(73) Assignee: Fraunhofer-Gesellschaft Zur Forderung Der Angewand, Munchen (DE)

(21) Appl. No.: 11/813,717

(22) PCT Filed: Jan. 12, 2006
(86) PCT No.: PCT/DE2006/000055

§ 371 Date: Sep. 11, 2007

(30) Foreign Application Priority Data
Jan. 14, 2005 (DE) 10 2005 002 670.2
Jan. 12, 2006 (DE) PCT/DE2006/000055

(51) Int. Cl. B23K 26/08

(52) U.S. Cl. 219/121.72

(57) ABSTRACT

The invention relates to a method for machining workpieces by using laser radiation, wherein the workpieces to be machined are moved during the machining and at least one laser beam is deflected with respect to two axes aligned orthogonally to one another. It is therefore the object of the invention to form large-area machining contours with as high a machining speed and as great an accuracy as possible. In the method in accordance with the invention, a procedure is followed that a laser beam is deflected within a working field with respect to two axes aligned orthogonally to one another. Positional coordinates of the respective machining contour are moreover associated in an electronic evaluation and control unit with virtual machining segments in which the machining is carried out sequentially. The borders of individual machining segments are predetermined so that the maximum spacing of mutually oppositely disposed borders of the respective machining segments does not exceed 50% of the maximum length of the working field for the laser beam in the feed direction of the moved workpiece.

### BACKGROUND

The invention relates to a method for machining workpieces by using laser radiation, wherein the workpieces to be machined are moved during the machining and at least one laser beam is deflected with respect to two axes aligned orthogonally to one another. High machining speeds and a corresponding machining accuracy can be achieved with the invention without the costs for the required plant engineering being increased with respect to conventional solutions. An automated movement contour programming is also possible.

The most varied contours can be machined which should also be formed on the workpiece in the form of irregular patterns or patterns which do not repeat. The machining contours can be dimensioned very large and can be substantially larger than a working field of a laser beam which can be deflected two-dimensionally by means of scanner mirrors.

Different types of machining such as cutting processes, stock removal processes, structuring processes, local material modifications (hardening) and weld connections can be carried out using the method.

A solution for the generation of repeating patterns in continuously moved flat material is described in DE 195 37 467 C1. In this process, bending or folding edges should be formed on or at the flat material instead of impressed markings which can be detected at the belt speed of the flat material for the control of a laser scanning system.

Such markings are, however, disadvantageous since they have to be formed additionally, which increases the cost for the plant engineering (stamping tools and detectors). Bending or folding edges, however, also impair regions of the flat material, as the workpiece, which may result in increased cutting waste. The machining speed cannot be optimized easily in the direction of shorter machining times.

A synchronization of stamping tools, feed speed and the control for the laser scanning system is moreover required.

### SUMMARY OF THE INVENTION

It is therefore the object of the invention to provide a method for the machining of moved workpieces by using laser radiation with which large-format machining contours can be formed at a machining speed which is as high as possible and an accuracy which is as great as possible.

In accordance with the invention, this object is solved using a methods as described herein. Advantageous aspects and further developments of the invention can be achieved using the features designated herein.

The method in accordance with the invention can be operated using plant engineering which is conventional per se. In this connection, a laser beam can be deflected by means of scanner mirrors such that a machining of workpieces within a working field is possible. As a rule, the working fields have an at least approximately rectangular or square design. As a rule, further elements are also arranged in the beam path of a laser beam for a beam shaping and a variation of the focal position of the laser beam.

The scanner mirrors as well as other elements for the influencing of the laser beam, also of its power, are as a rule connected to an electronic control. In this connection, measured signals are also frequently supplied to such an electronic control which can be evaluated in it and which can be taken into account in the control of the process.

It is obvious that a working field has a finite areal size and such large-format workpieces cannot be machined without at least a relative movement of the working field and the workpiece. With very large workpieces or also at high feed speeds, only the workpiece is usually moved. This applies in particular to long, band-shaped workpieces which are moved through beneath the fixed working field.

It was previously customary, e.g. in the laser beam cutting of rectangular geometrical contours from continuously moved band-shaped workpieces, to use two laser beams with which the two wide edges were cut simultaneously.

In contrast to this, in accordance with the invention, a deflection of the focal spot takes place such that a side of such a rectangular contour within a machining segment is moved through up to a border of the machining segment. When this border has been reached, a jump takes place, in which no machining is carried out, to the oppositely disposed side edge of the rectangular contour to be cut out. When this position has been reached, a machining again takes place with a simultaneous deflection of the focal point in the opposite direction up to the oppositely disposed border of this machining segment.

A complete machining within the respective machining segment can thereby take place within the available machining time influenced by the feed speed. The dead times on jumps in which a non-usable deflection takes place for the repositioning of the focal point can thus be minimized and both the machining time and the positioning for a further machining within the respective machining segment can be optimized.

A machining of plate-like elements can also take place with the invention if they e.g. rotate around a rotary axis and the total surface region or a large surface region of a rotating workpiece can thus be swept over by the working field of a laser beam. A circular workpiece can thus be machined, for example.

Not only workpieces with a planar, smooth surface can be machined, but also slightly curved workpieces or workpieces provided with a surface contour.

In accordance with the invention, position coordinates of the respective machining contour are supplied to an electronic evaluation and control unit which realizes the control of the laser optical elements, in particular of the scanner mirrors and optionally also of the laser power. Position coordinates of the machining contour are then associated with virtual machining segments.

In this connection, the spacing of the borders from the machining segments is selected such that it amounts to a maximum of half the length of the working field in the feed direction of the workpiece. The spacings of the borders should be selected to be as large as possible to be able to keep the number of machining jumps within machining segments small and to reduce the time, in particular dead times, required for the positioning or level control of the focal point.

The machining of the moving workpiece then takes place sequentially within machining segments. Accordingly, the machining contour within a machining segment is traced over by deflection of the laser beam. If the machining of this machining segment has terminated and the workpiece has been moved on with a corresponding feed, the machining of the machining segment following directly in the feed direction starts, etc. If the nominal feed speed reduces, the beam deflection changes, but not the actual machining speed (e.g. cutting speed) of the focal point on the workpiece. The process is idle until then next segment border has been passed. Constant machining speeds are thereby ensured independently of the feed speed.

The machining segments can be predetermined so that their respective borders have equal spacings from one another so that a respectively equal maximum work path can be covered between the borders. This is at least possible in the ranges of feed speeds of the workpiece. On substantial deviations from feed speeds, a changed spacing from borders of the machining segment can also be selected and a corresponding adaptation made. This can easily be realized by means of the electronic evaluation and control unit when a change in the feed speed of the workpiece has been initiated or detected.

If the maximum spacing of borders for machining segments is maintained at 50% or less than 50% of the respective length/extent of the working field which can be machined by the laser beam, a reliable, highly accurate machining can take place reliably while taking account of the respective machining contour within the machining segment. In this connection, the machining contours in machining segments are different as a rule and regular repetitions of machining contours do not have to be oriented on the boundary of the machining segments. The machining programs can be determined analytically, e.g. by an automatic program generation.

On the machining within a machining segment, a deflection of the focal point of the laser beam can take place in different directions, also changing directions, up to a deflection/movement against the feed direction of the workpiece.

It is, however, also favorable to detect the respective feed speed or the feed path or both in combination with one another and to take account thereof in the control of the laser beam deflection or focal point movement in order to increase the positional accuracy of the machining contour.

A feedback control or control of the laser power can also be carried out to be able to carry out different machining processes, for example, or to machine workpiece regions less or not at all by a reduction of the laser power. The latter can be achieved by a temporary switching off of the laser light source or by a substantial reduction of the power.

In this way, a cutting process can be carried out within machining segments and, at other positions, only a material removal for the forming of a perforation while taking account of corresponding predetermined positional coordinates of the machining contour.

Depending on the type of machining, with here in particular the required time for the respective machining playing a role, on the feed speed and/or on the machining contour of machining segments or of the total workpiece, it is possible to draw a conclusion on the maximum required machining speed, that is how fast the focal point has to be moved or the laser beam has to be deflected.

As already mentioned, the solution in accordance with the invention cannot only be used on workpieces moved in a translatory manner, such as bands, but the workpieces can also rotate around an axis of rotation. In this connection, the axis of rotation and the working field should be arranged at least partly offset to one another so that a complete coverage of the region of workpieces to be machined can be achieved by the working field. Accordingly, the axis of rotation is then always inside the working field. There is also the possibility of a superimposition of a translatory deflection of the working field on the rotary movement of the workpiece, e.g. by a corresponding translatory movement of a laser machining head. A machining in spiral form can thereby preferably be carried out with large, rotating workpieces.

The borders of the machining segments can then be defined while taking account of the maximum radius of the machining contour since the greatest feed speed has to be taken into account at the respectively largest radius. The demand for the spacing of the borders of a machining segment from one another of a maximum of 50% of the extent/length of the working field should then be satisfied on the largest radius of the machining contour so that an automatic program generation is possible.

There is also the possibility of forming markings (path stamp) on the workpiece with the laser beam in all or also in known selected machining segments or at regular spacings from one another using the laser beam, said markings preferably being able to be arranged in a cutting waste region of the workpiece. Their positions can be detected using suitable detectors, preferably measuring in a non-contact manner, and can be utilized for the further control/feedback control. Such a marking (path stamp) formed in every machining segment can also generate a signal for the electronic evaluation and control unit which then initiates the end and the start for a machining of a and of the machining segment downstream thereof in the direction of feed.

A decoupling of the machining speed from the feed speed is possible using the invention; said feed speed can accordingly be kept constant independently of the respective feed speed.

The most varied machining contours, even complex ones, can also be taken into account and reproducible working results can also be achieved.

The achievable machining speed is substantially only limited by the time constants with deflection speeds and well as the size of the working field. A taking into account of a grid is not necessary in the machining and the movement of the focal point or the deflection of the laser beam can be optimized in the individual machining segments while taking account of the predetermined machining contour.

The invention will be explained in more detail by way of example in the following.

### BRIEF DESCRIPTION OF THE DRAWINGS

There is shown

FIG. 1 illustrates the machining of a band-like plastic foil, by way of example as a workpiece, using the method in accordance with the invention, in schematic form.

### DETAILED DESCRIPTION OF EMBODIMENTS OF THE INVENTION

A machining on a plastic foil moved in a translatory manner as a workpiece 1 should be carried out using a laser beam with the method in accordance with the invention. The plastic foil can be clamped between two rollers, not shown here, and can be transported in a longitudinal direction, and a feed can thus be realized, by rolling up and down.

In this connection, the plastic film should be cut in a special shape with a predetermined marginal contour (solid line) using a laser beam which is two-dimensionally deflectable. A perforation (dashed line) should moreover be formed parallel to the feed direction. This can be achieved by a slight material removal, starting from the surface of the plastic foil.

The positional coordinates for the outer marginal contour and perforation were supplied in advance to an electronic evaluation and control unit and form the basis for the machining contour.

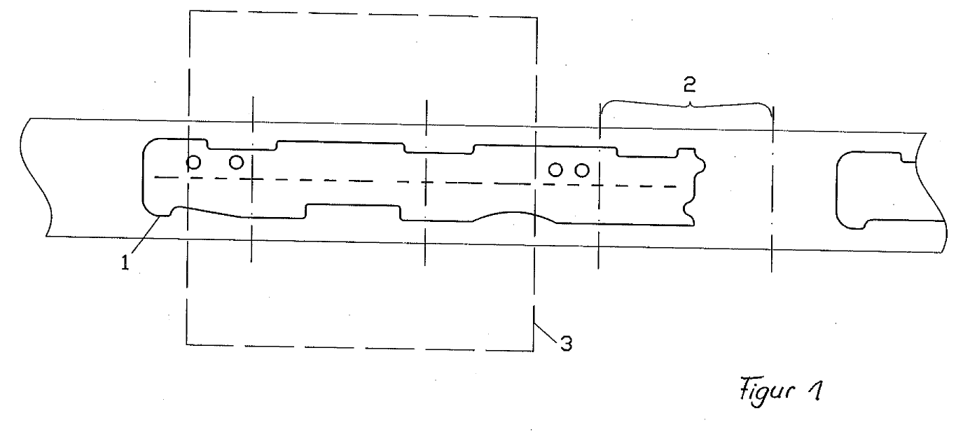

Such positional coordinates were associated with virtual machining segments 2 by means of the electronic evaluation and control unit. The machining segments are made recognizable by a figurative representation of their borders in FIG. 1. The borders are not really present on the plastic film.

The working field 3 is moreover shown which has been drawn here in overlap with two adjacent machining segments 2. It is thus made clear that the borders of the machining segments 2 have a spacing from one another which in this example corresponds to precisely half the length of the working field 3 in the feed direction.

It can furthermore be recognized that the machining contours in the individual machining segments 2 differ from one another and are not identical and also do not have to be identical. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for machining at least one workpiece by using laser radiation, wherein a laser beam can be deflected within a working field with respect to two axes aligned orthogonally to one another;
wherein positional coordinates of respective machining contours are associated in an electronic evaluation and control unit with virtual machining segments in which the machining is carried out sequentially;
wherein borders of the individual machining segments are predetermined such that the maximum spacing from mutually oppositely disposed borders of the respective machining segments does not exceed 50% of the maximum length of the working field for the laser beam in a feed direction of a moved workpiece.

2. A method in accordance with claim 1, wherein a band-like or plate-shaped workpiece is machined.

3. A method in accordance with claim 1, wherein the workpiece is moved in a translatory or rotary manner.

4. A method in accordance with claim 1 wherein one or both of one of respective feed speed and feed path of the workpiece are determined.

5. A method in accordance with claim 1 wherein a maximum required machining speed for the respective segment is determined while taking account of at least one of feed speed of the respective machining contour and of type of machining.

6. A method in accordance with claim 1 wherein different machining processes are carried out on a workpiece.

7. A method in accordance with claim 1 wherein at least one of focusing of the laser beam and power of the laser beam are feedback controlled in the machining.

8. A method in accordance with claim 1 wherein the borders of machining segments on rotating workpieces are predetermined such that the maximum spacing of borders of the machining segments is taken into account on a respectively largest radius of a machining contour.
